(19) United States
(12) Patent Application Publication
(10) Pub. No.: US 2025/0310263 A1
(43) Pub. Date: Oct. 2, 2025

(54) Systems and Methods for Packet Processing in Programmable Logic Devices

(71) Applicants: Nagabhushan Chitlur, Portland, OR (US); Ganapathi Singaravelu, Bangalore (IN); Dinesh Kotti, Saratoga, CA (US); Luan Bui, San Jose, CA (US); Xiaokang Xu, San Ramon, CA (US); Shashank Marwaha, Bengaluru (IN); Raghucharan Boddupalli, Bangalore (IN); Nilesh Sable, Bengaluru (IN)

(72) Inventors: Nagabhushan Chitlur, Portland, OR (US); Ganapathi Singaravelu, Bangalore (IN); Dinesh Kotti, Saratoga, CA (US); Luan Bui, San Jose, CA (US); Xiaokang Xu, San Ramon, CA (US); Shashank Marwaha, Bengaluru (IN); Raghucharan Boddupalli, Bangalore (IN); Nilesh Sable, Bengaluru (IN)

(21) Appl. No.: 18/620,712

(22) Filed: Mar. 28, 2024

(51) Int. Cl. H04L 47/125; H04L 47/11

(52) U.S. Cl. CPC H04L 47/125; H04L 47/11

(57) ABSTRACT

Systems or methods of the present disclosure may provide an integrated circuit system, including programmable logic fabric and transceiver circuitry coupled to the programmable logic fabric, wherein the transceiver circuitry includes a parser configurable to parse a packet to identify a number of headers, a number of header offsets, or both, an extractor configurable to extract a number of fields from the number of heads, the number of header offsets, or both, and a classifier configurable to classify the packet to a stream based on the number of fields.

### BACKGROUND

The present disclosure relates generally to packet processing. More particularly, the present disclosure relates to implementation of inline hardened packet processing functions to identify and route packet applications.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

Integrated circuits are found in numerous electronic devices, from handheld devices, computers, gaming system, robotic devices, automobiles, and more. At times, the integrated circuits may communicate via a wide data bus or high-capacity communication channel (e.g., a fat pipe). However, it may be difficult for programmable fabric used for applications of the integrated circuit to absorb the high-capacity communication channel and segregate the high-capacity communication channel into several packet processing pipelines. Further, it may be difficult for the integrated circuit to maintain deep packet processing in the programmable fabric at high port rates.

### BRIEF DESCRIPTION OF THE DRAWINGS

Various aspects of this disclosure may be better understood upon reading the following detailed description and upon reference to the drawings in which:

FIG. 1 is a block diagram of an integrated circuit system, in accordance with an embodiment of the present disclosure;

FIG. 2 is an example of circuitry that may be employed by a transceiver subsystem of the integrated circuit system of FIG. 1, in accordance with an embodiment of the present disclosure;

FIG. 3 is an example of circuitry that may be employed by the transceiver subsystem of the integrated circuit system of FIG. 1 used in performing inline hardened packet processing, in accordance with an embodiment of the present disclosure;

FIG. 4 is a block diagram illustrating load balancing and transmission via a number of pipelines, in accordance with an embodiment of the present disclosure;

FIG. 5 is a diagram of extractor circuitry employed by the transceiver subsystem of the integrated circuit system of FIG. 1, in accordance with an embodiment of the present disclosure;

FIG. 6 is a diagram of classifier circuitry employed by the transceiver subsystem of the integrated circuit system of FIG. 1, in accordance with an embodiment of the present disclosure;

FIG. 7 is an example illustration of a first hint format for packet hints, in accordance with an embodiment of the present disclosure; and

FIG. 8 is an example illustration of a second hint format for the packet hints, in accordance with an embodiment of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

The present systems and techniques relate to embodiments for implementing inline hardened packet processing functions to identify and route packet applications. For example, implementations for processing for an incoming packet may be split (e.g., divided) between hard logic and soft logic. Indeed, an integrated circuit system (e.g., an integrated circuit package) may receive an incoming packet via a transceiver subsystem. The transceiver subsystem may include hardened packet processing functions (e.g., implemented in hardware) to process the incoming packet such as parser circuitry, extractor circuitry (e.g., field extractor circuitry), and/or classifier circuitry (e.g., traffic classifier circuitry). The parser circuitry may include any number of analyzer stages, which may enable identification of a number of headers present in the packet. The number of headers identified in each of the number of analyzer stages may be combined to provide data indicative of the headers and header offsets present in the packet. Further, the data may be provided (e.g., sent, transmitted) to the extractor circuitry, to enable the extractor circuitry to use the data to extract fields of interest specified via a user input and/or other indications. The extractor circuitry may then produce values associated with the extracted fields.

The values associated with the extracted fields and the data may be provided to and processed (e.g., used) by the classifier circuitry, which may then classify the packets in multiple streams. Moreover, load balancer circuitry may route the packets in the multiple streams to a number of processing pipelines based on the classification to enable load balancing of incoming traffic. Therefore, processing and/or separation of the packets performed by the transceiver subsystem (e.g., hardened circuitry), may enable operation at increased levels of frequency. Further, performance of the separation by the transceiver subsystem may enable an increase in line rates for Infrastructure Processing Unit (IPU) applications. That is, the separation into the multiple streams (e.g., at lower rates) may be more efficiently handled by the programmable logic fabric. It should be noted that, in some embodiments, the parser circuitry, the extractor circuitry, the classifier circuitry, and/or the load balancer circuitry may be fully programmable to enable specification of a protocol parse graph and/or the fields used for extraction and classification.

In some embodiments, the number of analyzer stages of the parsing circuitry may provide a bit key, which represents a presence or absence of a number of protocols within the packet header. The bit key may enable the transceiver subsystem to perform an exact match lookup, which may provide an indication of a sequence of protocols within the packet. For example, the indication may be referred to as a hint type (e.g., P-Type). For each hint type, the user may program a bit map to cause the extractor circuitry to extract particular fields within the packet headers. The particular fields may then be used to provide a number of packet hints for each of the packets. The extracted fields may be combined (e.g., bundled) with the packet hints and transported to the programmable logic fabric separately from the packet being sent. As such, the packet hints may improve packet processing by enabling the programmable logic fabric to efficiently identify or determine a type of processing that will be used on an arriving packet. Indeed, the packet hints may enable the programmable logic fabric to make efficient processing decisions on each of the incoming packets received.

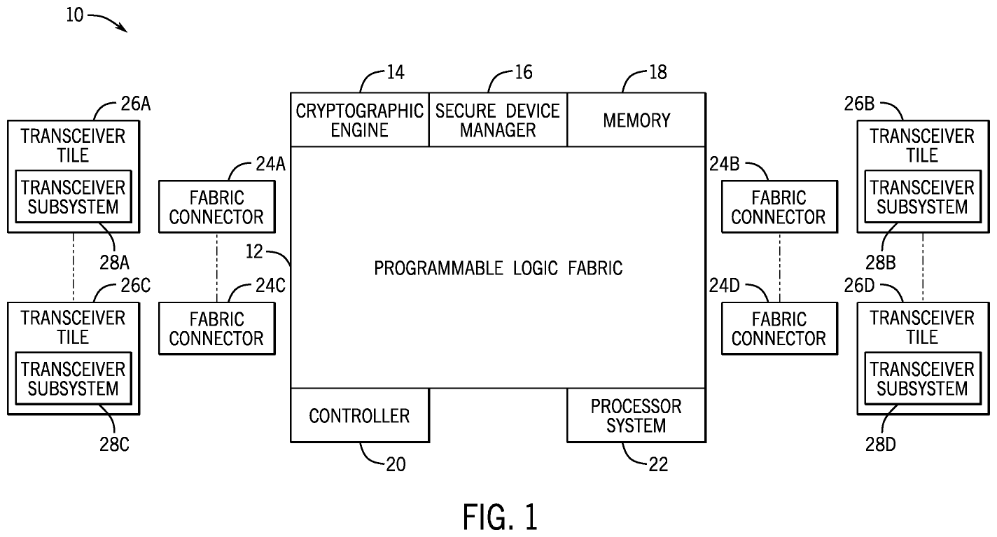

With the foregoing in mind, FIG. 1 is a block diagram of an integrated circuit system 10 (e.g., an integrated circuit package, a programmable logic device). The integrated circuit system 10 may include programmable logic fabric 12 (e.g., programmable logic circuitry, field programmable gate array (FPGA)), which may include programmable routing circuitry and programmable logic (sometimes referred to as logic array blocks (LABs) or configurable logic blocks (CLBs)). The programmable logic fabric 12 may include circuitry that can be configurable or programmed to implement specific logic functions. For example, configuration data may be used to program all of or a portion of the programmable logic fabric 12 to implement circuit designs to carry out numerous operations or functions.

The programmable logic fabric 12 may be part of an integrated circuit that includes a cryptographic engine 14; a device controller, such as a secure device manager (SDM) 16; a memory 18; hardened memory controller(s) 20, and a hardened processor system 22. The cryptographic engine 14 may include a hardware component or a software component (e.g., running on the hardened processor system 22) that is designed to perform cryptographic operations securely. For example, the cryptographic engine 14 may execute cryptographic algorithms such as encryption, decryption, hashing, and/or verification. The SDM 16 may receive bitstreams of configuration data and provide the configuration to be programmed into the programmable logic fabric 12. The SDM 16 may also provide protection for sensitive data and the cryptographic operations, such as by storing cryptographic keys. The SDM 16 may be designed to be resistant to security attacks, such as attempts to extract sensitive information or modification of the functionality of the SDM 16.

The memory 18 may include any suitable memory included in integrated circuit, such as an embedded static random-access memory (eSRAM). The hardened memory controller(s) 20 may be a hardware component that may manage and control communication between the programmable logic fabric 12 or the hardened processor system 22 and other memory (e.g., external memory such as a version of double data rate (DDR) memory or high-bandwidth memory (HBM)).

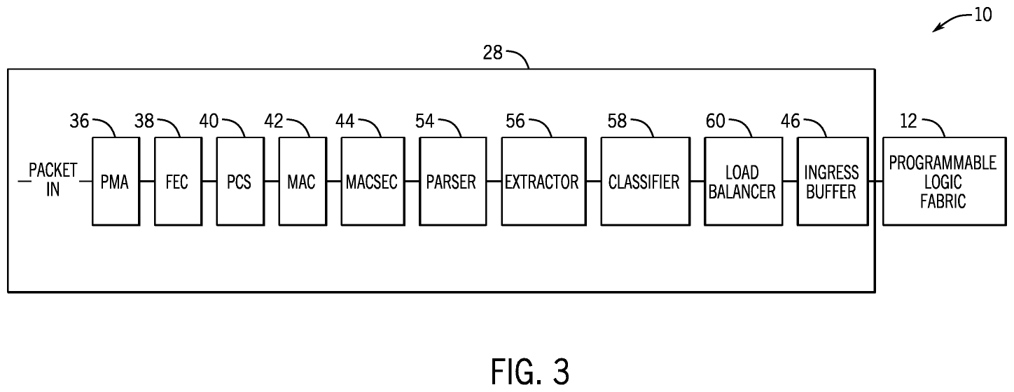

The integrated circuit system 10 may include fabric connectors 24 (e.g., 24A, 24B, 24C, 24D), which may enable communication and data exchange between multiple processing cores or memory blocks in the integrated circuit system 10. The fabric connectors 24 may also enable connections between different components or blocks (e.g., logic blocks) within the integrated circuit system 10. As an example, the fabric connectors 24 may include an Embedded Multi-die Interconnect Bridge (EMIB). As another example, the fabric connectors 24 may enable communication via Universal Chip Interconnect Express (UCIE), which is a connection protocol that facilitates data transfer and communication between various components or systems. Further, the integrated circuit system 10 may include transceiver tiles 26 (e.g., 26A, 26B, 26C, 26D). The transceiver tiles 26 may each contain transceivers that enable transmission or receipt of data over suitable communication links. The transceiver tiles 26 may be configurable to include a certain number of transceivers with specific operating parameters. Further, the transceiver tiles 26 may support different communication protocols, enabling compatibility with various other devices or systems. The transceiver tiles 26 may each include a transceiver subsystem 28 (e.g., 28A, 28B, 28C, 28D), which may enable performance of operations described herein, such as the inline hardened packet processing functions (e.g., parsing, extracting, classifying). In some embodiments, the transceiver subsystem 28 may be a part of a monolithic FPGA, where interfaces from the transceiver subsystem 28 may be present on the same die as the FPGA fabric, without use of the UCIE interface. Additional details regarding the transceiver subsystem 28 (e.g., transceiver circuitry) will be described below with respect to FIGS. 3-6.

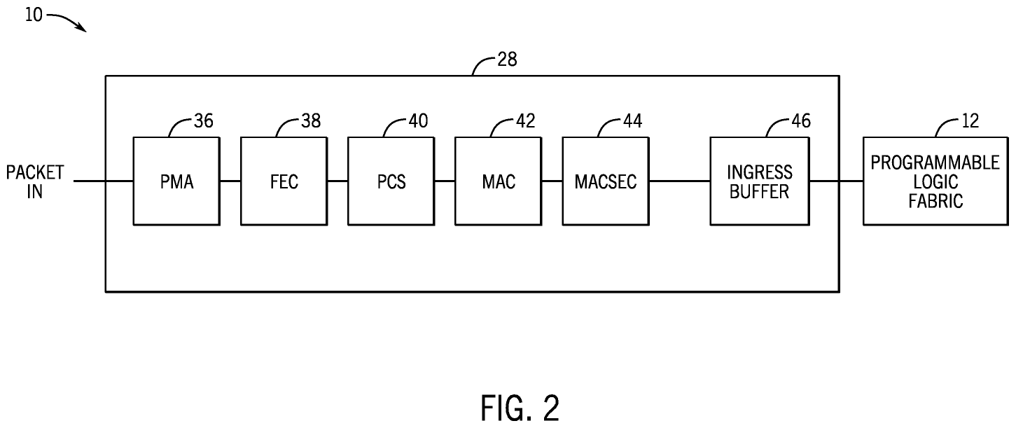

With the foregoing in mind, FIG. 2 is a diagram of an example of circuitry that may be employed by the transceiver subsystem 28 of the integrated circuit system 10, in accordance with an embodiment of the present disclosure. The programmable logic fabric 12 may serve as a recipient of a packet of information from the transceiver subsystem 28.

An incoming packet may be received at a physical medium attachment (PMA) sublayer 36, which is a sublayer that may interface with a physical medium to handle data serialization and/or deserialization for data reception. The packet may then be transmitted to forward error correction (FEC) 38, which may detect and correct errors that may occur in the received packet. Moreover, the packet may be transmitted to a physical coding sublayer (PCS) 40, which is a data link layer that may handle encoding and/or decoding of signals before transmission or after receipt.

The packet may then be transmitted to a Media Access Control (MAC) circuitry 42, which may include a set of protocols and mechanisms to control how various devices and/or different circuitry access shared communication channels, such as a network (e.g., Ethernet, Wi-Fi, and so on) or a wireless channel. A Media Access Control security (MACsec) circuitry 44 may receive the packet from the MAC circuitry 42, which may be encrypted. The MACsec circuitry 44 may then decrypt or decode the packet. The MACsec circuitry 44 may then transmit the decrypted packet to a buffer 46 (e.g., an ingress buffer) to be stored before being transmitted to the programmable logic fabric 12.

After receiving the packet at the programmable logic fabric 12, the programmable logic fabric 12 may perform the packet processing functions. For example, the packet processing functions may be performed in layer 2 (e.g., a data link layer) and any suitable layer above layer 2 of the Open Systems Interconnection (OSI) model. The packet processing functions may include flow control buffering, parsing classification, policing, security functions, queuing, scheduling, packet buffering, and/or packet editing. Therefore, the programmable logic fabric 12 may store, analyze, and load balance incoming traffic into multiple packet processing streams within fabric of the programmable logic fabric 12. As a result, it may be challenging for the programmable logic fabric 12 to process high-capacity communication channels (e.g., fat pipes, elephant flows). Further, the programmable logic fabric 12 may be limited on a frequency of operation. For example, the frequency of operation may be less than a frequency of operation for hard logic.

As another example, the frequency of operation for the programmable logic fabric 12 may be 450 Megahertz (MHz). At this frequency, a bandwidth that may be managed (e.g., handled) by a single pipeline for an Ethernet application may be limited to a range of 200-300 Gigabits per second (Gbps). Thus, the single pipeline may not be able to manage large flows where port rates are 400 Gbps and above. Additionally, the programmable logic fabric 12 may implement a store and forward model for the packet processing. The store and forward model may involve large buffers and packet resident times in the buffers may be long. As such, packet processing by the programmable logic fabric 12 may involve several limitations.

With the foregoing in mind, FIG. 3 is an example of circuitry that may be employed by the transceiver subsystem 28 of FIG. 1 used in performing inline hardened packet processing, in accordance with an embodiment of the present disclosure. That is, the packet processing functions may be moved from the programmable logic fabric 12 to the transceiver subsystem 28, which includes hardened circuitry to perform the packet processing to at least partially alleviate bottlenecking in or into the programmable logic fabric 12 that may occur when performing these functions in the programmable logic fabric 12. Therefore, as illustrated, the transceiver subsystem 28 may include parser circuitry 54, extractor circuitry 56, classifier circuitry 58, and/or load balancer circuitry 60. Additionally or alternatively, the parser circuitry 54, the extractor circuitry 56, the classifier circuitry 58, and/or the load balancer circuitry 60 may be implemented using the processor system 22. Additionally or alternatively, the parser circuitry 54, the extractor circuitry 56, the classifier circuitry 58, and/or the load balancer circuitry 60 may be implemented in the integrated circuit system 10 via configuration data loaded into the memory 18. Additionally, as described herein, the transceiver subsystem 28 may include the MACsec circuitry 44, the MAC circuitry 42, the PCS 40, the FEC 38, and the PMA 36 as previously discussed in relation to FIG. 2.

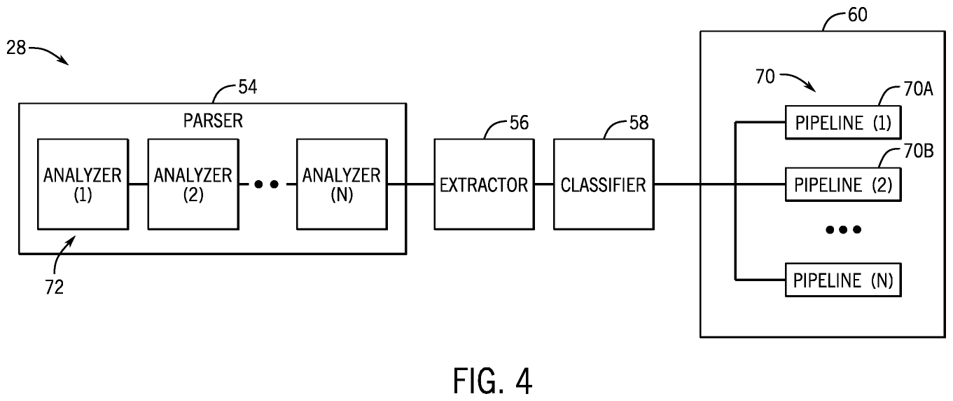

As previously discussed, the transceiver subsystem 28 may receive an incoming packet. The packet may be transmitted to the PMA 36, the FEC 38, the PCS 40, the MAC circuitry 42, and/or the MACsec circuitry 44. The transceiver subsystem 28 may then provide the packet to the parser circuitry 54 for parsing and identification of headers of the packet, as well as header offsets. Further, the identified headers and header offsets may be provided to the extractor circuitry 56. The extractor circuitry 56 may then extract fields of interest from the identified headers and the header offsets. In some embodiments, the fields of interest may be specified by the user. Moreover, the extracted fields of interest may be provided to the classifier circuitry 58. The classifier circuitry 58 may use values associated with the extracted fields and the headers of the packet to classify packets in different streams. The different streams may then be routed to a number of fabric processing pipelines for load balancing at the load balancer circuitry 60. Additional details regarding each of the packet processing functions will be described below with respect to FIGS. 4-6.

FIG. 4 is a block diagram illustrating load balancing and transmission via a number of pipelines 70 (e.g., routes to processing blocks implemented in the programmable logic fabric 12), in accordance with an embodiment of the present disclosure. As illustrated, the load balancing may be performed via the parser circuitry 54, the extractor circuitry 56, the classifier circuitry 58, and/or the load balancer circuitry 60. Additionally, as described herein, the parser circuitry 54, the extractor circuitry 56, the classifier circuitry 58, and/or the load balancer circuitry 60 may be a part of the transceiver subsystem 28.

The parser circuitry 54 may parse a packet by analyzing the packet via a number of analyzer stages 72. That is, the packet may be analyzed at each analyzer stage 72 to identify a number of headers present within the packet. As an example, the parser circuitry 54 may parse up to 256 bytes of the packet. Additionally or alternatively, the parser circuitry 54 may examine bit patterns in the headers to determine information in the packet and/or how the packet was encoded. For example, the headers may include information (e.g., data) associated with a source address, a destination address, protocol information, packet length, a packet sequence, encoding information, and so on. Moreover, the packet may be analyzed at each analyzer stage 72 to identify header offsets (e.g., position of a specific header of the headers). It should be noted that the parser circuitry 54 may include any suitable number of analyzer stages 72.

After parsing the packet, the parser circuitry 54 may provide the information associated with the headers and/or the header offsets identified at each of the analyzer stages 72 to the extractor circuitry 56. For example, the header offsets may be provided as parse pointers. The extractor circuitry 56 may extract fields of interest from the information associated with the headers and/or the parse pointers in the packet. In some embodiments, the extractor circuitry 56 may extract the fields of interest based on predefined patterns and/or rules. For example, a user or other mechanism may specify (e.g., define) a set of rules or patterns that the extractor circuitry 56 may follow to identify the fields of interest from the information associated with the headers and/or the parse pointers. Additionally or alternatively, the user may select (e.g., choose) any parsed-extracted bits of the packet.

The extractor circuitry 56 may provide values associated with the extracted fields of interest as well as the information associated with the headers and/or the parse pointers to the classifier circuitry 58. The classifier circuitry 58 may then use the values of the extracted fields of interest and the information associated with the headers and/or header offsets to classify the packet into a first stream, which is then routed to a first pipeline 70A to a first location in the programmable logic fabric 12. In a similar manner, an additional packet may be received and parsed by the parser circuitry 54, extracted by the extractor circuitry 56, and classified by the classifier circuitry 58. The additional packet may be classified into a second stream by the load balancer circuitry 60, which is then routed to a second pipeline 70B to a second location in the programmable logic fabric 12.

Accordingly, the packet and the additional packet may be pre-processed by the hardened packet processing functions and load balanced via the load balancer circuitry 60 to identify and route packets to the appropriate locations of the programmable logic fabric 12. Thus, the programmable logic fabric 12 may more efficiently receive the packet processing streams (e.g., fabric virtual queues) via the number of pipelines 70. That is, spreading the packet processing streams over the number of pipelines 70 enables each of the streams to be sent at a lower frequency at the individual pipelines without reducing the overall throughput. Therefore, management of the packet processing streams by the programmable logic fabric 12 may be improved.

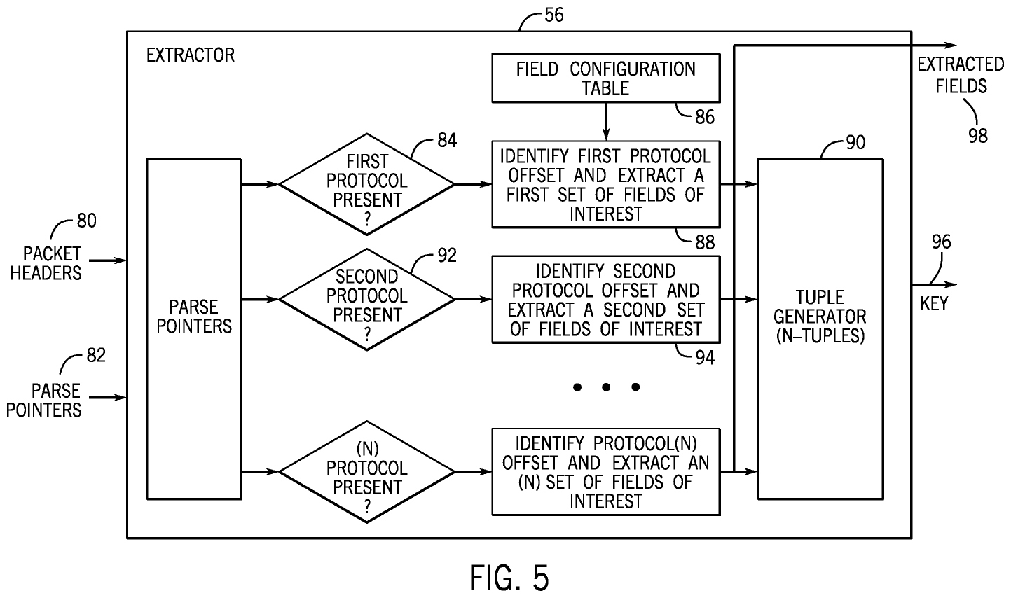

With the foregoing in mind, FIG. 5 is a diagram of the extractor circuitry 56 that may be employed by the transceiver subsystem 28 of FIG. 1, in accordance with an embodiment of the present disclosure. As described herein, the extractor circuitry 56 may receive the packet headers 80 (e.g., headers) and the offset for each header as parse pointers 82. The parse pointers 82 may point to (e.g., identify) specific parts of data in the packet headers 80 and may enable efficient extraction of the fields. At block 84, the extractor circuitry 56 may determine if a first protocol is present based on the parse pointers 82. The extractor circuitry 56 may also include a field configuration table 86, which may provide information related to fields that may be extracted on a per protocol basis. For example, the field configuration table 86 may be input (e.g., provided) by the user and implemented as a bit map (e.g., 4-bit, 8-bit, 16-bit granularity, or any other suitable bit size granularity).

At block 88, if the first protocol is present, the extractor circuitry 56 may identify (e.g., determine) a first protocol offset for each field for the first protocol and extract a first set of fields of interest from the packet headers 80. The first protocol offset may be identified based on the first protocol, the packet headers 80, and/or the field configuration table 86. The extractor circuitry 56 may then provide the first set of fields of interest to a tuple generator 90. It should be noted that the extractor circuitry 56 may repeat this process any number of times depending on a number of protocols present. For example, at block 92, the extractor circuitry 56 may determine if a second protocol is present. Further, at block 94, the extractor circuitry 56 may identify a second protocol offset for the second protocol and extract a second set of fields of interest from the packet headers 80. The extractor circuitry 56 may then provide the second set of fields of interest to the tuple generator 90.

The tuple generator 90 may use the first set of fields of interest and the second set of fields of interest to create a key 96. For example, the tuple generator 90 may include functions for extracting the key from the fields of each tuple that is generated by the tuple generator 90. Moreover, the tuple generator 90 may create the key 96 based on a user application, which may be identified by a header sequence of the packet. The extractor circuitry 56 may then provide the key 96 to the classifier circuitry 58. Additionally, the extractor circuitry 56 may provide extracted fields 98 to the classifier circuitry 58 and/or any other suitable location.

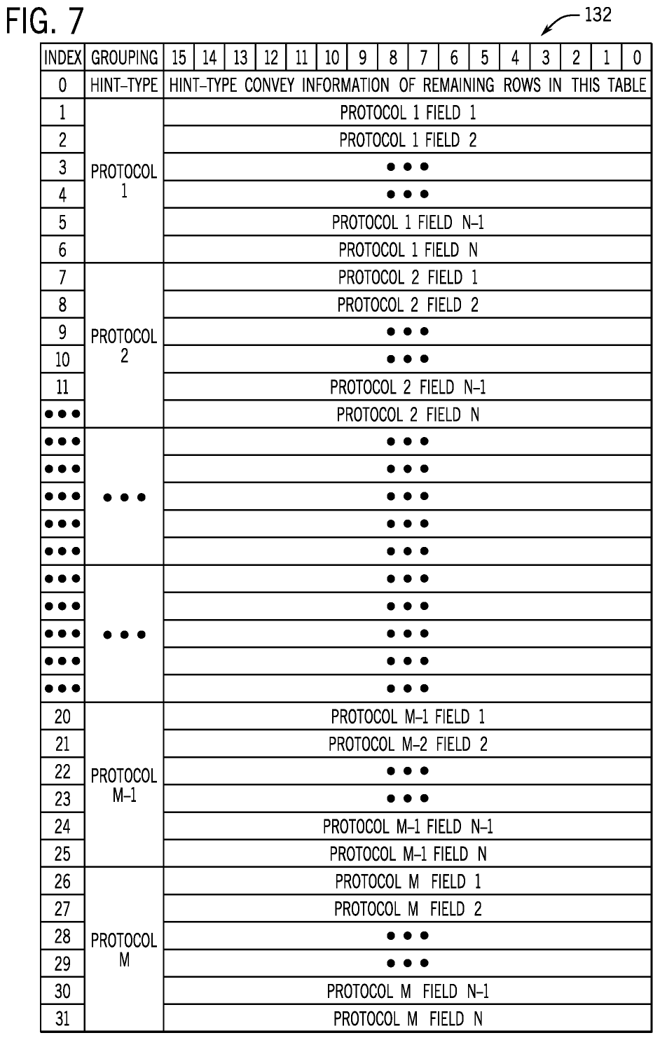

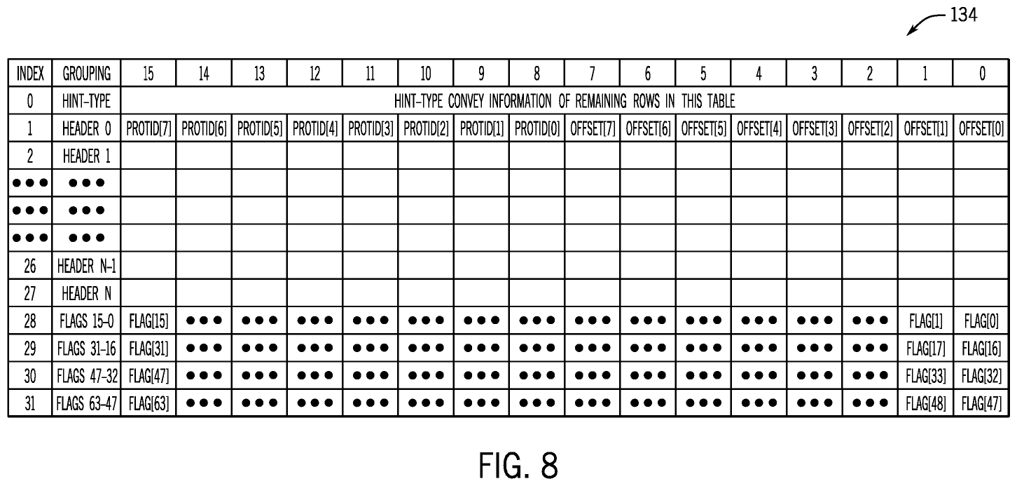

In some embodiments, the extractor circuitry 56 may generate packet hints based on the extracted fields 98. The packet hints may be provided to the programmable logic fabric 12 to provide data and/or metadata to the programmable logic fabric 12 before the packet arrives. Indeed, the extractor circuitry 56 may bundle the extracted fields 98 and transport the packet hints to the programmable logic fabric 12 independent of the packet being sent or simultaneously (e.g., in parallel) as the packet being sent. The packet and the packet hints may be bound by a common sequence identification (ID). In this manner, the programmable logic fabric 12 may more efficiently process the packet by enabling more efficient decision-making based on the data provided in the packet hints. Further, in some embodiments, the packet hints may enable the programmable logic fabric 12 to determine a type of packet processing. Additional details with respect to the packet hints will be described below with respect to FIGS. 7 and 8.

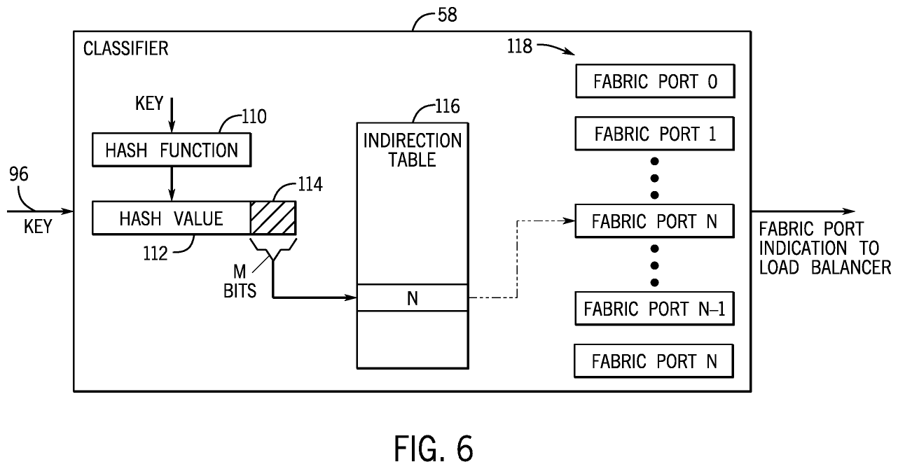

With the foregoing in mind, FIG. 6 is a diagram of classifier circuitry 58 employed by the transceiver subsystem 28 of FIG. 1, in accordance with an embodiment of the present disclosure. The classifier circuitry 58 may receive the key 96 from the extractor circuitry 56. The classifier circuitry 58 may include a hash function 110 that may receive the key as an input and output (e.g., generate) a hash value 112 (e.g., a string of bits). A number of (m) bits 114 of the hash value 112 may be mapped to an indirection table 116.

In some embodiments, the number of bits 114 mapped to the indirection table 116 may depend on a load balancing granularity of the classifier circuitry 58. The indirection table 116 may include a number of entries that may indicate each of the number of bits 114 and their mapping to each of a number of ports 118 (e.g., a number of fabric ports). That is, the number of bits 114 may represent a number n and may be mapped to a port n 118 using the indirection table 116. For example, if the number of bits 114 represent ‘4’, then the number of bits 114 may be mapped to port ‘4’ 118 using the indirection table 116. The classifier circuitry 58 may generate an indication that indicates the port 118 and provide the indication to the load balancer circuitry 60.

As described herein, the transceiver subsystem 28 may provide the packet hints to the programmable logic fabric 12 and/or the user to enable more efficient processing of the packets. As an example, the packet hints may be provided in a first hint format or a second hint format. Each of the first hint format and the second hint format may include a number of rows and each row may include a number of bits (e.g., a hint group). For example, the first hint format may include 32 rows and each of the 32 rows may include 16 bits (e.g., 2 bytes) or any other suitable number of bits. Therefore, a total amount of hint information may include 512 bits or any other suitable number of bits. In some embodiments, the user may select between the first hint format or the second hint format.

The first row of each of the first hint format and the second hint format may be referred to as a hint-type (e.g., a P-type) and may include information to enable identification of the hint information. The hint-type may enable establishment of commonality between the hint information sent by the pipelines 70 and soft functions that may be implemented in the programmable logic fabric 12. The user or another mechanism may program (e.g., via software) the hint-type for the hardened packet processing functions of the transceiver subsystem 28 and/or the functions of the programmable logic fabric 12. By using the hint-type, the programmable logic fabric 12 may process remaining hint groups provided in a hint table of the first hint format or the second hint format.

FIG. 7 is an example illustration of a first hint format 132 for the packet hints that may be provided to the programmable logic fabric 12, in accordance with an embodiment of the present disclosure. As described above, the first hint format 132 may comply with the formatting of the hint table illustrated in FIG. 7. The hint table may include the hint-type group as the first row and remaining groups of the first hint format 132. Moreover, the remaining groups of the first hint format 132 may include field information extracted by the extractor circuitry 56.

In the first hint format 132, each field may be 16-bit (or another suitable size of) granularity and may represent a field extracted from the packet headers 80. For example, the user or another mechanism may define the extraction of a number of fields per protocol. A value of the number of fields for each protocol may differ and may also be configurable. As another example, the number of extracted fields may be two fields for a second protocol, four fields for a third protocol, three fields for a fourth protocol, and so on. Further, the hint-type group may be encoded to represent the combination of fields. In some embodiments, a total amount of groups may be limited to any suitable number, such as 32 (e.g., 64 bytes or any other suitable number of bytes and/or groups). Any of the defined/encoded values may be defined by the user and/or may be retrieved from storage.

FIG. 8 is an example illustration of a second hint format 134 for the packet hints, in accordance with an embodiment of the present disclosure. The second hint format 134 may also comply with the formatting of the hint table illustrated in FIG. 8, which includes the hint-type group and the remaining groups of the second hint format. Moreover, the remaining groups/rows of the second hint format 134 may include packet header protocol stack information and a number of flags. Each group of the remaining groups may be divided into a first part and a second part. The first part may include a protocol ID of any suitable length (e.g., 8-bits). For example, the protocol ID may represent up to 256 (or another number of) possible protocols in the packet header protocol stack. The second part may include offset information of any suitable size (e.g., 8-bit offset). Further, the offset information may provide a location of an associated protocol in the packet header. The flags may be programmable and carry information associated with an outcome of each of the pipelines 70 for each of the packets.

By using information of the flags, the programmable logic fabric 12 may more efficient decisions for packet handling. In some embodiments, the protocol ID and/or the flags may be defined and/or programmed by the user. It should be noted that FIGS. 7 and 8 are merely illustrative examples of packet hint formats that may be employed by the integrated circuit system 10 of FIG. 1 and any other suitable packet hint format may also be employed.

While the embodiments set forth in the present disclosure may be susceptible to various modifications and alternative forms, specific embodiments have been shown by way of example in the drawings and have been described in detail herein. However, it should be understood that the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

### EXAMPLE EMBODIMENTS

EXAMPLE EMBODIMENT 1. An integrated circuit system including programmable logic fabric and transceiver circuitry coupled to the programmable logic fabric. The transceiver circuitry includes a parser configurable to parse a packet to identify a number of headers, a number of header offsets, or both, an extractor configurable to extract a number of fields from the number of headers, the number of header offsets, or both, and a classifier configurable to classify the packet to a stream based on the number of fields.

EXAMPLE EMBODIMENT 2. The integrated circuit system of example embodiment 1, including a load balancer configurable to route the stream to the programmable logic fabric via a processing pipeline.

EXAMPLE EMBODIMENT 3. The integrated circuit system of example embodiment 1, wherein the parser is configurable to parse the packet via a number of analyzer stages.

EXAMPLE EMBODIMENT 4. The integrated circuit system of example embodiment 1, wherein the number of header offsets comprise parse pointers.

EXAMPLE EMBODIMENT 5. The integrated circuit system of example embodiment 1, wherein the extractor is configurable to extract the number of fields.

EXAMPLE EMBODIMENT 6. The integrated circuit system of example embodiment 1, wherein the extractor includes a field configuration table configurable to provide information associated with the number of fields.

EXAMPLE EMBODIMENT 7. The integrated circuit system of example embodiment 6, wherein the field configuration table includes a bit map.

EXAMPLE EMBODIMENT 8. The integrated circuit system of example embodiment 1, wherein the extractor includes a tuple generator configurable to generate a key based on the number of fields.

EXAMPLE EMBODIMENT 9. The integrated circuit system of example embodiment 8, wherein the classifier includes an indirection table and is configurable to generate a hash value based on the key and map the hash value to a port via the indirection table.

EXAMPLE EMBODIMENT 10. The integrated circuit system of example embodiment 9, wherein the classifier is configurable to provide an indication of the port to a load balancer circuitry.

EXAMPLE EMBODIMENT 11. The integrated circuit system of example embodiment 1, wherein the extractor is configurable to generate a number of packet hints and provide the number of packet hints to the programmable logic fabric.

EXAMPLE EMBODIMENT 12. The integrated circuit system of example embodiment 11, wherein the number of packet hints includes a hint-type configurable to enable the programmable logic fabric to process the packet.

EXAMPLE EMBODIMENT 13. The integrated circuit system of example embodiment 11, wherein the packet hints include a first hint format or a second hint format.

EXAMPLE EMBODIMENT 14. The integrated circuit system of example embodiment 1, including a transceiver tile that includes the transceiver circuitry.

EXAMPLE EMBODIMENT 15. A transceiver system including parser circuitry configurable to parse a packet to identify a plurality of parse pointers, extractor circuitry configurable to determine a protocol is present in the packet based at least in part on the parse pointers, identify a protocol offset and extract a set of fields of interest based on the protocol and a field configuration table, and generate a key based on the protocol offset and the set of fields of interest, and classifier circuitry configurable to receive the key, generate a hash value based on the key, and identify a port for the packet based on the hash value and an indirection table.

EXAMPLE EMBODIMENT 16. The transceiver system of example embodiment 15, wherein the classifier circuitry is configurable to provide an indication including the port to a load balancer.

EXAMPLE EMBODIMENT 17. The transceiver system of example embodiment 15, wherein the classifier circuitry is configurable to generate the hash value based on a hash function.

EXAMPLE EMBODIMENT 18. The transceiver system of example embodiment 15, wherein the field configuration table is user-defined.

EXAMPLE EMBODIMENT 19. A method for pre-processing data in transceiver circuitry including receiving data at the transceiver circuitry to be transmitted to a programmable logic fabric, parsing, using parsing circuitry of the transceiver circuitry, a first packet of the data to identify a first number of headers, a first number of header offsets, or both, extracting, using extraction circuitry of the transceiver circuitry, a first number of fields from the first number of headers, the first number of header offsets, or both, classifying, using classification circuitry of the transceiver circuitry, the first packet to a first stream based on the first number of fields, and transmitting the first stream via a first processing pipeline from the transceiver circuitry to the programmable logic fabric.

EXAMPLE EMBODIMENT 20. The method of example embodiment 19, including parsing, using the parsing circuitry, a second packet to identify a second number of headers, a second number of header offsets, or both, extracting, using the extraction circuitry, a second number of fields from the second number of headers, a second number of header offsets, or both, classifying, using the classification circuitry, the second packet to a second stream based on the second number of fields, and transmitting the second stream via a second processing pipeline from the transceiver circuitry to the programmable logic fabric.

What is claimed is:

1. An integrated circuit system, comprising:
programmable logic fabric; and
transceiver circuitry coupled to the programmable logic fabric, wherein the transceiver circuitry comprises:
a parser configurable to parse a packet to identify a number of headers, a number of header offsets, or both;
an extractor configurable to extract a number of fields from the number of headers, the number of header offsets, or both; and
a classifier configurable to classify the packet to a stream based on the number of fields.

2. The integrated circuit system of claim 1, comprising a load balancer configurable to route the stream to the programmable logic fabric via a processing pipeline.

3. The integrated circuit system of claim 1, wherein the parser is configurable to parse the packet via a number of analyzer stages.

4. The integrated circuit system of claim 1, wherein the number of header offsets comprise parse pointers.

5. The integrated circuit system of claim 1, wherein the extractor is configurable to extract the number of fields.

6. The integrated circuit system of claim 1, wherein the extractor comprises a field configuration table configurable to provide information associated with the number of fields.

7. The integrated circuit system of claim 6, wherein the field configuration table comprises a bit map.

8. The integrated circuit system of claim 1, wherein the extractor comprises a tuple generator configurable to generate a key based on the number of fields.

9. The integrated circuit system of claim 8, wherein the classifier comprises an indirection table and is configurable to:
generate a hash value based on the key; and
map the hash value to a port via the indirection table.

10. The integrated circuit system of claim 9, wherein the classifier is configurable to provide an indication of the port to a load balancer circuitry.

11. The integrated circuit system of claim 1, wherein the extractor is configurable to generate a number of packet hints and provide the number of packet hints to the programmable logic fabric.

12. The integrated circuit system of claim 11, wherein the number of packet hints comprises a hint-type configurable to enable the programmable logic fabric to process the packet.

13. The integrated circuit system of claim 11, wherein the packet hints comprise a first hint format or a second hint format.

14. The integrated circuit system of claim 1, comprising a transceiver tile that comprises the transceiver circuitry.

15. A transceiver system, comprising:
parser circuitry configurable to parse a packet to identify a plurality of parse pointers;
extractor circuitry configurable to:
determine a protocol is present in the packet based at least in part on the parse pointers;
identify a protocol offset and extract a set of fields of interest based on the protocol and a field configuration table; and
generate a key based on the protocol offset and the set of fields of interest; and
classifier circuitry configurable to:
receive the key;
generate a hash value based on the key; and
identify a port for the packet based on the hash value and an indirection table.

16. The transceiver system of claim 15, wherein the classifier circuitry is configurable to provide an indication comprising the port to a load balancer.

17. The transceiver system of claim 15, wherein the classifier circuitry is configurable to generate the hash value based on a hash function.

18. The transceiver system of claim 15, wherein the field configuration table is user-defined.

19. A method for pre-processing data in transceiver circuitry, comprising:
receiving data at the transceiver circuitry to be transmitted to a programmable logic fabric;
parsing, using parsing circuitry of the transceiver circuitry, a first packet of the data to identify a first number of headers, a first number of header offsets, or both;
extracting, using extraction circuitry of the transceiver circuitry, a first number of fields from the first number of headers, the first number of header offsets, or both;
classifying, using classification circuitry of the transceiver circuitry, the first packet to a first stream based on the first number of fields; and
transmitting the first stream via a first processing pipeline from the transceiver circuitry to the programmable logic fabric.

20. The method of claim 19, comprising:
parsing, using the parsing circuitry, a second packet to identify a second number of headers, a second number of header offsets, or both;
extracting, using the extraction circuitry, a second number of fields from the second number of headers, a second number of header offsets, or both;
classifying, using the classification circuitry, the second packet to a second stream based on the second number of fields; and
transmitting the second stream via a second processing pipeline from the transceiver circuitry to the programmable logic fabric.
